(19) United States
(12) Patent Application Publication
(10) Pub. No.: US 2007/0223747 A1
(43) Pub. Date: Sep. 27, 2007

(54) Narrow speaker unit and image display apparatus having the narrow speaker

(75) Inventors: Hitoshi Torisaki, Saitama-ken (JP); Hiroshi Asaba, Tokyo-to (JP)

Correspondence Address: NATH & ASSOCIATES, PLLC, Sixth Floor, 1030 15th Street, N.W., Washington, DC, 20005, US

(73) Assignee: VICTOR COMPANY OF JAPAN, LIMITED, Yokohama-shi (JP)

(21) Appl. No.: 11/727,231

(22) Filed: Mar. 26, 2007

(30) Foreign Application Priority Data
Mar. 24, 2006 (JP) P2006-083952
Jan. 31, 2007 (JP) P2007-020707

(51) Int. Cl. H04R 25/00

(52) U.S. Cl. 381/182; 381/433

(57) ABSTRACT

A narrow speaker unit includes a diaphragm including first and second cone-type vibrating sections, a first drive section driving the first vibrating section, the first drive section attached to the first vibrating section with a drive center of the first vibrating section displaced in the longitudinal direction from the center of the first vibrating section, and a second drive section driving the second vibrating section, the second drive section attached to the second vibrating section with a drive center of the second vibrating section displaced in the longitudinal direction from the center of the second vibrating section.

### CROSS REFERENCE TO RELATED APPLICATIONS AND INCORPORATION BY REFERENCE

This application is based upon and claims the benefit of priority from prior Japanese Patent Application P2006-083952 filed on Mar. 24, 2006 and Japanese Patent Application P2007-020707 filed on Jan. 31, 2007; the entire contents of which are incorporated by reference herein.

### BACKGROUND OF THE INVENTION

1. Field of the Invention

The present invention relates to a narrow speaker unit and an image display apparatus to which the narrow speaker unit is attached.

2. Description of the Related Art

In recent years, screens of television receivers, especially flat panel displays such as liquid crystal displays (LCDs) and plasma display panels (PDPs), are getting larger. There is a demand for a design in which a front panel area, other than the screen, is reduced as much as possible in order to minimize space required for installation of a large screen television receiver in a room. Accordingly, the front panel around the screen where a speaker unit (hereinafter, also referred to as a ‘speaker’) is attached has a very small width. The speaker is generally attached on either side of the screen or under the screen within the front panel.

To attach an ordinary round speaker inside such a narrow front panel around the screen, the diameter of the diaphragm of the speaker is inevitably extremely small. Such a small diameter speaker has difficulty to output sufficient sound pressure and, hence, cannot provide high quality sound. If a speaker having an elliptic (oval) diaphragm is used, the diaphragm can be designed to have an area larger than an area of a circular diaphragm, and the sound pressure can be increased. A speaker including not only an elliptic diaphragm but a substantially rectangular diaphragm can also provide a similar effect. Such speakers, each having an elongated diaphragm shape, such as an ellipse or rectangle, are generically referred to as ‘narrow speakers’.

A dynamic speaker provided with a general paper cone causes a so-called partial resonance, which the paper cone resonates, at some frequencies, cannot properly vibrate to generate sound. When the partial resonance occurs, peaks and troughs are created in reproduction frequency characteristics, thus causing distortion and abnormally reproduced sound. Various methods have been proposed to reduce the partial resonance, one of which is used for a so-called oblique cone speaker in which the central axis of a voice coil is not aligned with the central axis of the diaphragm (paper cone). In the oblique cone speaker, resonant frequencies at which partial resonance occurs can be dispersed, and the reproduction frequency characteristic can be made flatter than the reproduction frequency characteristic of a normal speaker, i.e., non-oblique cone speaker, thus making it possible to reduce distortion in reproduced sound.

In the aforementioned narrow speakers, the oblique cone speakers is effective for reducing the partial resonance.

As described above, it is preferable to use the oblique cone narrow speaker as the speaker attached inside the narrow front panel around the screen of an image display apparatus, such as a television receiver, in order to increase the area of the diaphragm for increasing sound pressure and also reducing the partial resonance. It is desirable to further reduce that partial resonance of the oblique cone narrow speaker in order to improves the sound quality. Moreover, to attach the oblique cone narrow speaker to the image display apparatus, it is necessary to optimize the position and orientation of the oblique cone narrow speaker in consideration of a sound radiation pattern specific to the oblique cone narrow speaker. If the oblique cone narrow speaker is attached to the image display apparatus at a position and orientation which are not optimized in consideration of the sound radiation pattern specific to the elongated speaker, the sound spread and a sense of sound localization may be degraded. Accordingly, there is a demand for an image display apparatus provided with oblique cone narrow speakers having maximized sound features.

### SUMMARY OF THE INVENTION

An aspect of the present invention inheres in a narrow speaker unit having an elongated shape in longitudinal and lateral directions of a sound emitting surface. The narrow speaker includes a diaphragm having first and second cone-type vibrating sections which are arranged in the longitudinal direction and integrally formed, each of the first and second vibrating sections having an elongated shape in the longitudinal and lateral directions; a first drive section driving the first vibrating section, the first drive section being attached to the first vibrating section with a drive center of the first vibrating section being displaced in the longitudinal direction from a central position of the first vibrating section; and a second drive section driving the second vibrating section, the second drive section being attached to the second vibrating section with a drive center of the second vibrating section being displaced in the longitudinal direction from a central position of the second vibrating section.

### BRIEF DESCRIPTION OF THE DRAWINGS

FIG. 1 is a front view showing a narrow speaker unit according to a first embodiment of the present invention;

FIG. 2 is a side view of the narrow speaker unit of FIG. 1, partially in cross section;

FIGS. 3A to 3B are schematic plan views showing a sound radiation pattern of the narrow speaker unit of FIG. 1;

FIG. 4 is a front view showing an example of an image display apparatus including the narrow speaker unit of FIG. 1 attached;

FIG. 5 is a front view showing a narrow speaker unit according to a second embodiment of the present invention;

FIG. 6 is a schematic plan view showing a sound radiation pattern of the narrow speaker unit of FIG. 5;

FIG. 7 is a perspective view showing an example of an image display apparatus including the narrow speaker unit of FIG. 5 attached;

FIG. 8 is a front view showing a narrow speaker unit according to a third embodiment of the present invention;

FIG. 9 is a schematic plan view showing a sound radiation pattern of the narrow speaker unit of FIG. 8;

FIG. 10 is a front view showing an example of image display apparatus including the narrow speaker unit of FIG. 8 attached;

FIG. 11 is a front view showing a narrow speaker unit according to a fourth embodiment of the present invention;

FIGS. 12A to 12B are schematic plan views showing a sound radiation pattern of the narrow speaker unit of FIG. 11;

FIG. 13 is a front view showing a first example of the image display apparatus including the narrow speaker unit of FIG. 11 attached;

FIG. 14 is a front view showing a second example of the image display apparatus including the narrow speaker unit of FIG. 11 attached;

FIG. 15 is a front view showing a third example of the image display apparatus including the narrow speaker unit of FIG. 11 attached;

FIG. 16 is front view showing a narrow speaker unit according to a fifth embodiment of the present invention;

FIG. 17 is a perspective view showing an example of an image display apparatus including the narrow speaker unit of FIG. 16 attached;

FIG. 18 is front view showing a narrow speaker unit according to a sixth embodiment of the present invention;

FIG. 19 is a perspective view showing an example of an image display apparatus including the narrow speaker unit of FIG. 18 attached;

FIG. 20 is a front view showing a narrow speaker unit according to a seventh embodiment of the present invention; and

FIGS. 21A to 21B are characteristic diagrams for comparison between frequency characteristics of one of the embodiments of the present invention and an example of the related art.

### DETAILED DESCRIPTION OF THE INVENTION

Various embodiments of the present invention will be described with reference to the accompanying drawings. It is to be noted that the same or similar reference numerals are applied to the same or similar parts and elements throughout the drawings, and the description of the same or similar parts and elements will be omitted or simplified.

In the following descriptions, numerous specific details are set forth such as specific signal values, etc., to provide a thorough understanding of the present invention. However, it will be obvious to those skilled in the art that the present invention may be practiced without such specific details.

One aspect of the configuration (a first configuration example) of the present invention is a narrow speaker unit characterized in that the first and second drive sections are displaced toward the center of the narrow speaker unit in the longitudinal direction and respectively attached to the first and second vibrating sections.

Another aspect of the configuration (a second configuration example) of the present invention is a narrow speaker unit characterized in that the first and second drive sections are displaced outward toward the opposite sides to the center of the narrow speaker unit in the longitudinal direction and respectively attached to the first and second vibrating sections.

Still another aspect of the configuration (a third configuration example) of the present invention is a narrow speaker unit characterized in that the first drive unit is displaced outward in the longitudinal direction toward a side opposite to the first center of the narrow speaker unit and attached to the first vibrating section and that the second drive unit is displaced inward in the longitudinal direction toward the center of the narrow speaker unit and attached to the second vibrating section.

In a fourth configuration example obtained by modifying the first configuration example, the present invention provides a narrow speaker unit characterized in that the length of the first vibrating section in the longitudinal direction is longer than the length of the second vibrating section in the longitudinal direction.

In a fifth configuration example obtained by modifying the second configuration example, the present invention provides a narrow speaker unit characterized in that the length of the first vibrating section in the longitudinal direction is longer than the length of the second vibrating section in the longitudinal direction.

In a sixth configuration example obtained by modifying the third configuration example, the present invention provides a narrow speaker unit characterized in that the length of the second vibrating section in the longitudinal direction is longer than the length of the first vibrating section in the longitudinal direction.

In order to solve the aforementioned problems of the related art, the present invention provides an image display apparatus; including the narrow speaker units of the first configuration example which are arranged in right and left portions of a front panel around the display screen with the longitudinal directions vertical. Moreover, the present invention provides an image display apparatus including the narrow speaker unit of the second configuration example which is arranged in a bottom central portion of a front panel around the display screen with the longitudinal direction horizontal. Further, the present invention provides an image display apparatus including the narrow speaker units of the third configuration example which are arranged at right and left ends of a bottom portion of a front panel around the display screen with the longitudinal directions horizontal so that the first vibrating sections are located horizontally inside in the bottom portion and the second vibrating sections are located horizontally outside in the bottom portion.

The present invention provides an image display apparatus including the narrow speaker units of the fourth configuration example at right and left ends of a bottom portion of a front panel around the display screen with the longitudinal direction horizontal so that the first vibrating sections are located horizontally inside in the bottom portion and the second vibrating sections are located horizontally outside in the bottom portion. Moreover, the present invention provides an image display apparatus characterized in that the narrow speaker units of the fourth configuration example are arranged at right and left ends of a bottom portion of a front panel around the display screen with the longitudinal direction horizontal so that the first vibrating section is located horizontally outside in the bottom portion and the second vibrating section is located horizontally inside in the bottom portion. Further, the present invention provides an image display apparatus characterized in that the narrow speaker units of the fourth configuration example are arranged in right and left portions of a front panel around the display screen with the longitudinal direction vertical so that the first and second vibrating sections of each of the narrow speaker units are located on lower and upper sides, respectively, of one of the right and left portions.

Furthermore, the present invention provides an image display apparatus characterized in that the narrow speaker units of the fifth configuration example are arranged in right and left portions of a front panel around a display screen with the longitudinal direction vertical. Moreover, the present invention provides an image display apparatus characterized in that the narrow speaker units of the sixth configuration example are arranged at right and left ends of a bottom portion of a front panel around the display screen with the longitudinal direction horizontal so that the second vibrating section is located horizontally outside in the bottom portion and the first vibrating section is located horizontally inside in the bottom portion.

### First Embodiment

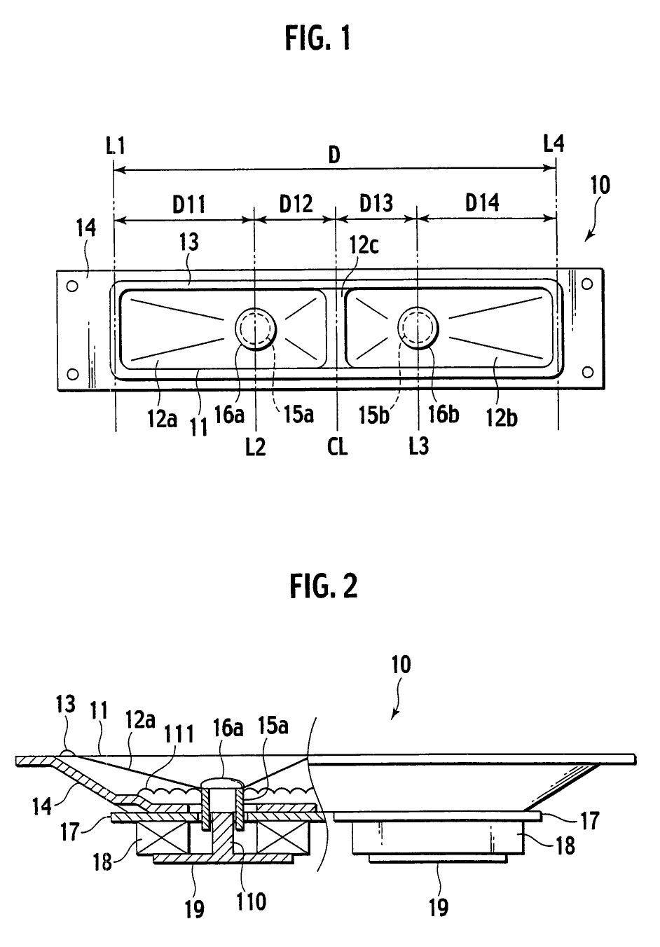

FIG. 1 is a front view showing a narrow speaker unit according to a first embodiment of the present invention, and FIG. 2 is a side view of the narrow speaker unit of FIG. 1, partially in cross section. As shown in FIGS. 1 and 2, a narrow speaker unit 10 according to the first embodiment includes a single diaphragm 11. The diaphragm 11 is in the shape of a rectangle with corners rounded off in a front view of a sound emitting surface and includes two small size vibrating sections 12a and 12b. The vibrating sections 12a and 12b are connected by a connecting section 12c. The two vibrating sections 12a and 12b and connecting section 12c integrally form the single diaphragm 11. The diaphragm 11 may be elliptically shaped in the front view, instead of having a rectangular shape, in the first embodiment and the other embodiments described later. In the present invention, each of the diaphragm and two vibrating sections has an elongated shape in the longitudinal and lateral directions of the sound emitting surface.

An outer peripheral edge of the diaphragm 11 is fixed to a frame 14 by an edge 13. The edge 13 may be a body different from the diaphragm 11 or may be a part of the outer peripheral edge of the diaphragm 11. The vibrating sections 12a and 12b have mortar-like cone shapes with the depth gradually increasing from the outer peripheral edges to respective openings to which cylindrical bobbins 15a and 15b with voice coils (not shown) wound therearound are fixed. The bobbins 15a and 15b are provided in the back side of the diaphragm 11. Dust caps 16a and 16b are attached to the vibrating sections 12a and 12b so as to close the openings to which the bobbins 15a and 15b are fixed.

In FIG. 1, the lateral direction (the vertical direction in the drawing) and longitudinal direction (the horizontal direction in the drawing) of the diaphragm 11 (the vibrating sections 12a and 12b) are referred to as ‘a width direction’ and ‘a length direction’, respectively. When the vibrating sections 12a and 12b are rectangular, the lateral and longitudinal directions are the short and long side directions, respectively. When the vibrating sections 12a and 12b are elliptical, the lateral and longitudinal directions are minor and major axis directions, respectively. The distance between a pair of clash-dotted lines L1 and L4 passing through centers of both end portions of the edge 13 of the diaphragm 11 in the length direction is indicated by a length D. As shown in FIG. 1, the vibrating section 12a is an oblique cone type with the bobbin 15a being displaced inwardly from a central line CL of the connecting section 12c in the length direction of the vibrating section 12a toward the center of the vibrating section 12a. Herein, the central line CL is a line at the center of the length D of the diaphragm 11. The vibrating section 12b is an oblique cone type with the bobbin 15b being displaced inwardly from the central line CL in the length direction of the vibrating section 12b. The bobbins 15a and 15b are located at the center of the diaphragm 11 in the width direction.

The positions of the bobbins 15a and 15b with the wound voice coils are drive centers when the vibrating sections 12a and 12b are vibrated. Accordingly, the narrow speaker unit 10 is an oblique cone type with the drive centers of the vibrating sections 12a and 12b being displaced toward the central line CL and the drive centers of the vibrating sections 12a and 12b being shifted from the centers thereof in the length direction toward the central line CL.

The vibrating sections 12a and 12b are symmetrically arranged in the length direction with respect to the central line CL. Lines passing through central points of the bobbin 15a and 15b in the vibrating sections 12a and 12b are indicated by L2 and L3, respectively. In the narrow speaker unit 10 according to the first embodiment, a distance D11 between the lines L1 and L2, a distance D12 between the line L2 and central line CL, a distance D13 between the central line CL and line L3, and a distance D14 between the lines L3 and L4 have the following relations:

D11=D14, D12=D13, D11>D12, D13<D14

As shown in FIG. 2, in the bottom part of the frame 14, top plates 17, each having an opening at the center, are fixed by caulking and an adhesive or the like. A pole piece 110 is integrally provided for a bottom yoke 19. The pole piece 110 and bottom yoke 19 form substantially a T-shape in a cross section. The top end of the pole piece 110 is inserted into the bottom end of the bobbin 15a. The bobbin 15a is inserted through a magnetic gap formed between an edge of the opening formed in the top plate 17 and the pole piece 110. An annular magnet 13 is fixed to the top plate 17 by an adhesive, and the bottom yoke 19 is fixed to the magnet 18 by an adhesive. The frame 14, top plate 17, magnet 18, and bottom yoke 19 constitute a fixed part of the narrow speaker unit 10.

The bobbin 15a is fixed to the opening formed in the paper cone constituting the vibrating section 12a as described above, and the dust cap 16a covers the opening. The vibrating section 12a may be formed of a material other than paper, and the material thereof is not limited. An inner peripheral edge of an annular dumper 111 is fixed to the outer peripheral surface of the bobbin 15a by an adhesive, and an outer peripheral edge of the annular dumper 111 is fixed to the frame 14 by an adhesive. The bobbin 15a with the wound voice coil is elastically supported on the frame 14 by the dumper 111 and the edge 13 with the paper cone of the vibrating section 12a interposed therebetween. The vibrating section 12a, edge 13, bobbin 15a, dust cap 16a, and dumper 111 constitute the moving part of the narrow speaker unit 10. The bobbin 15a with the wound voice coil, top plate 17, magnet 18, bottom yoke 19, and pole piece 110 constitute the drive part driving the vibrating sections 12a and 12b.

Herein, only the configuration of the vibrating section 12a is shown. However, the configuration of the vibrating section 12b is the same. In the narrow speaker unit 10 according to the first embodiment, the frame 14 is a common part to the vibrating sections 12a and 12b, and the other parts are independently provided for the vibrating sections 12a and 12b.

The aforementioned narrow speaker unit 10 according to the first embodiment, the single diaphragm 11 includes the two vibrating sections 12a and 12b, each of which is an oblique cone type. The partial resonance occurring in the narrow speaker unit 10 can be therefore reduced as compared to the partial resonance of the speaker unit of the related art.

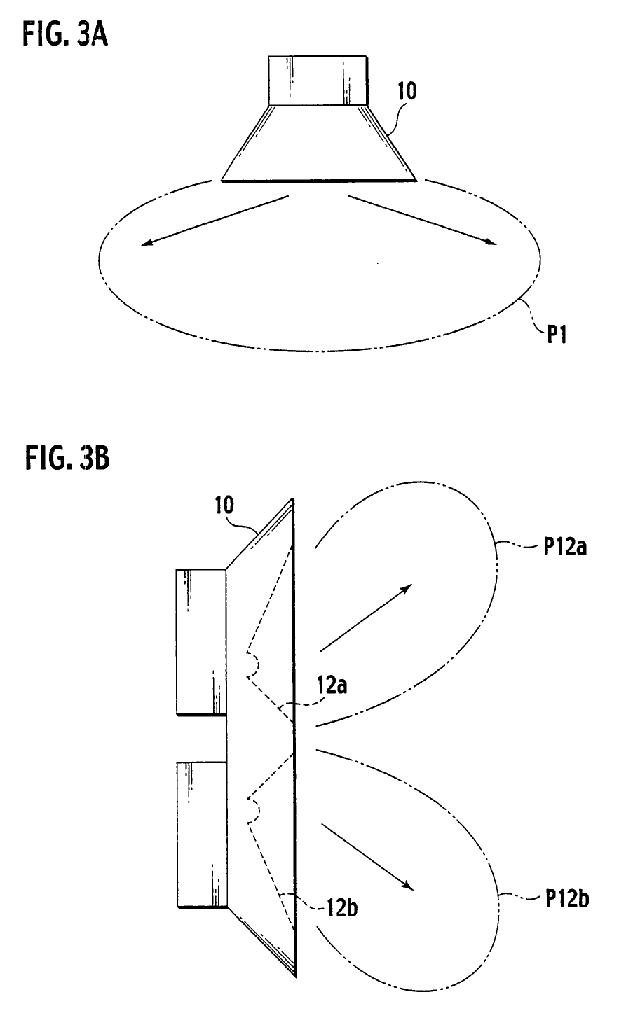

Next, a description is given of a preferred way to attach the narrow speaker unit 10 to the display apparatus considering the sound radiation pattern specific to the narrow speaker unit 10 according to the first embodiment. FIG. 3A is a schematic plan view of the narrow speaker unit 10 from an end in the length direction. FIG. 3B is a schematic side plan view of the narrow speaker unit 10 with the length direction being vertical. In a general narrow speaker unit, the directivity in the width direction is wider than the directivity in the length direction. Accordingly, in the narrow speaker unit 10, the radiation pattern of sound emitted from the narrow speaker unit 10 corresponds to a radiation pattern P1 shown in FIG. 3A in a view from an end in the length direction. The vibrating sections 12a and 12b are the oblique cone type with the bobbins 15a and 15b being displaced toward the central line CL. Therefore, as shown in FIG. 3B, the radiation sound pattern emitted from the vibrating section 12a corresponds to a radiation pattern P12a unevenly extending upward in the side view, and the radiation sound pattern emitted from the vibrating section 12b is a radiation pattern P12b unevenly extending downward in the side view.

Since the narrow speaker unit 10 according to the first embodiment includes the radiation patterns P1, P12a, and P12b as shown in FIGS. 3A and 3B, it is preferable that the narrow speaker unit 10 is arranged on either side of a display screen (hereinafter, abbreviated as screen) 101 of the image display apparatus 100. Specifically, it is preferable to attach the narrow speaker units 10 to right portion 102R and left portion 102L of the front panel 102 with the length direction being vertical. The narrow speaker units 10 are attached inside the right potion 102R and left potion 102L. Usually, the narrow speaker units 10 are not visible when the image display apparatus 100 is viewed from the outside, but herein the display apparatus 100 is shown with the narrow speaker units 10 being visible in order to schematically show positions and orientations of the narrow speaker units 10. In areas of the front panel 102 corresponding to the portions to which the narrow speaker units 10 are attached, fine holes for emitting sound are formed, through which sound from the narrow speaker units 10 is emitted.

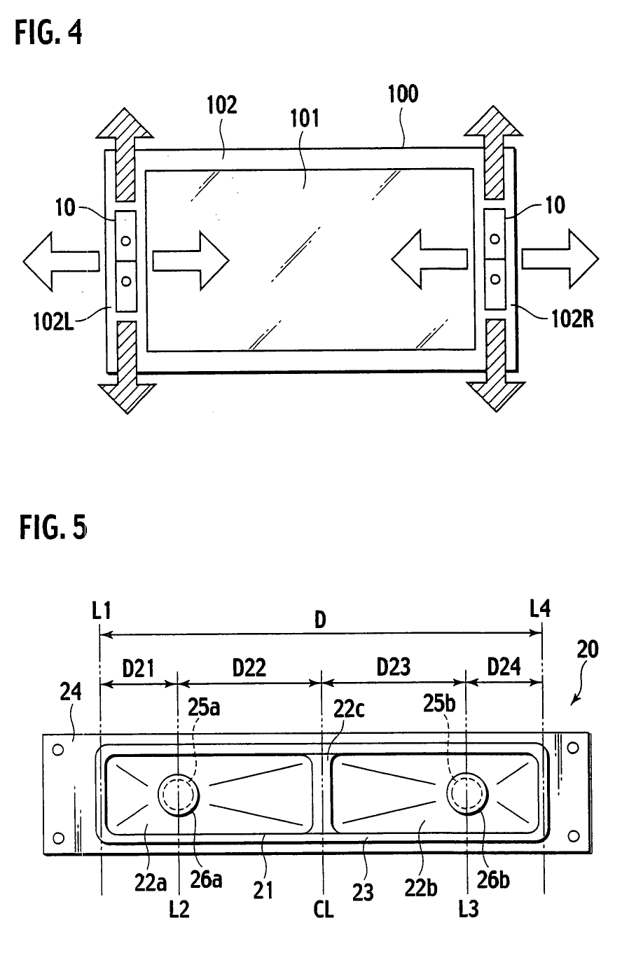

FIG. 4 schematically shows directions of sound emitted from the narrow speaker units 10 by arrows. Arrows not hatched indicate a state where sound spreads horizontally based on the radiation pattern P1, which is described in FIG. 3A. Hatched arrows indicate a state where sound spreads vertically based on the radiation patterns P12a and P12b resulting from the vibrating sections 12a and 12b of the oblique cone type, which are described in FIG. 3B. In the image display apparatus 100 including the narrow speaker units 10 attached to the right portion 102R and left portion 102L of the front panel 102, sound spreads horizontally and vertically from the right and left narrow speaker units 10 in such a manner that a sense of excellent sound spread can be obtained.

According to the narrow speaker unit of the present invention, the partial resonance is further reduced, and the sound quality is improved. Moreover, according to the narrow speaker unit of the present invention, the sound spread and sense of sound localization is improved when using the image display apparatus with the narrow speaker units attached thereto.

According to the image display apparatus of the present invention, the image display apparatus can provide high quality sound with less partial resonance. Moreover, according to the image display apparatus of the present invention, the sound spread and sense of sound localization is improved by taking into account the radiation patterns of the oblique cone narrow speakers.

### Second Embodiment

In a second embodiment of the present invention, a description is mainly given of points different from the first embodiment, and a description of common portions is properly omitted. FIG. 5 is a front view showing a narrow speaker unit according to the second embodiment of the present invention. As shown in FIG. 5, the narrow speaker unit 20 according to the second embodiment includes a single diaphragm 21. The diaphragm 21 is rectangular with corners rounded off in a front view of the sound emitting surface and includes two cone-shaped vibrating sections 22a and 22b of the same size. The vibrating sections 22a and 22b are connected by a connecting section 22c. The outer peripheral edge of the diaphragm 21 is fixed to a frame 24 by an edge 23.

As shown in FIG. 5, the vibrating section 22a is an oblique cone type with the positions of a bobbin 25a and a dust cap 26a being displaced outwardly from the center of the vibrating section 22a toward the opposite side to a central line CL of the connecting section 22c in the length direction of the vibrating section 22a. Herein, the central line CL is a line at the center of a length D of the diaphragm 21. The vibrating section 22b is an oblique cone type with the positions of a bobbin 25b and a dust cap 26b being displaced outwardly from the center of the vibrating section 22b toward the opposite side to the central line CL in the length direction of the vibrating section 22b. The vibrating sections 22a and 22b are arranged in the length direction symmetrically with respect to the central line CL. In the narrow speaker unit 20 according to the second embodiment, a distance D21 between the lines L1 and L2, a distance D22 between the line L2 and central line CL, a distance D23 between the central line CL and line L3, and a distance D24 between the lines L3 and L4 have the following relations:

D21=D24, D22=D23, D21<D22, and D23>D24

In the narrow speaker unit 20 according to the second embodiment, similar to the narrow speaker unit 10 according to the first embodiment, the vibrating sections 22a and 22b are the oblique cone type with drive centers being displaced from the respective centers of the vibrating sections 22a and 22b in the length direction. The partial resonance occurring in the narrow speaker unit 20 can be reduced compared to the partial resonance of the speaker unit of the related art.

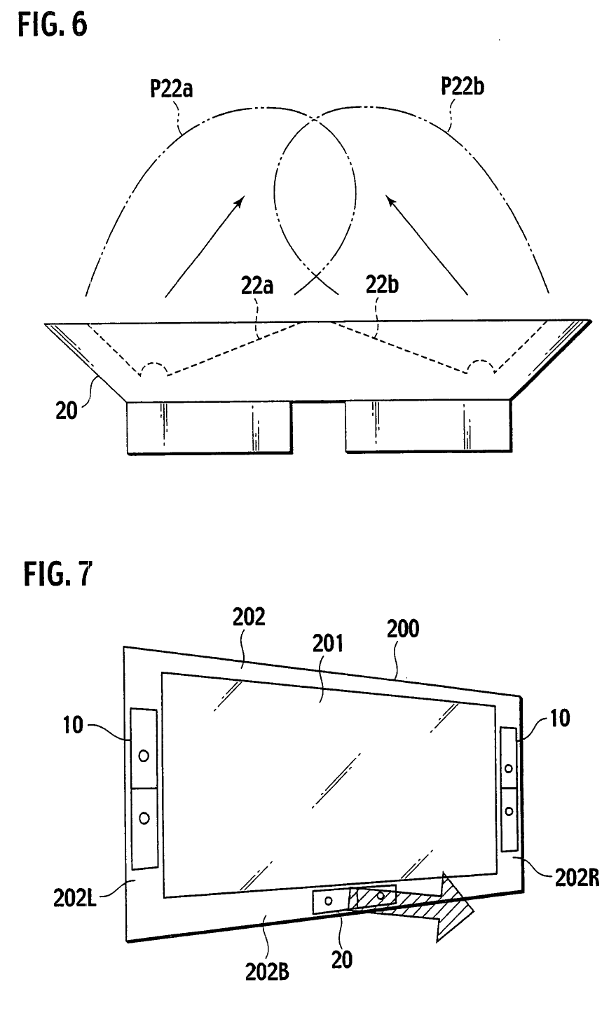

Next, a description is given of a preferred way to attach the narrow speaker unit 20 to the image display apparatus considering a sound radiation pattern specific to the narrow speaker unit 20 according to the second embodiment. The radiation pattern of sound emitted from the narrow speaker unit 20 in a view from an end in the length direction is the radiation pattern P1 shown in FIG. 3A, which is the same as the radiation pattern of the first embodiment. FIG. 6 is a schematic: side plan view of the narrow speaker unit 20 with the length direction horizontal. The vibrating sections 22a and 22b are the oblique cone type with the bobbins 25a and 25b (drive centers) being displaced outwardly in the length direction, respectively. Accordingly, the radiation pattern of sound emitted from the vibrating section 22a is a radiation pattern P22a that extends unevenly inward (toward the central line CL) in FIG. 6, and the radiation pattern of sound emitted from the vibrating section 22b is a radiation pattern P22b also extends unevenly inward (toward the central line CL).

Since the narrow speaker unit 20 according to the second embodiment includes the radiation patterns P22a and P22b shown in FIG. 6, it is preferable that the narrow speaker unit 20 is arranged under a screen 201 of the image display apparatus 200 as shown in FIG. 7. Specifically, it is preferable to attach the narrow speaker unit 20 to the middle of a bottom portion 202B of the front panel 202 with the length direction horizontal as a center speaker. In the narrow speaker unit 20, the sound radiation patterns P22a and P22b emitted from the vibrating sections 22a and 22b extends unevenly toward the central line CL, and the radiation patterns P22a and P22b are combined as shown in FIG. 7. Sound is therefore emitted forwardly from the center of the narrow speaker unit 20 in the length direction as indicated by a hatched arrow. In FIG. 7, the state where sound is emitted based on the radiation pattern P1 is not shown.

In the image display apparatus 200 including the narrow speaker unit 20 attached to the middle of the bottom portion 202B of the front panel 202, it is therefore possible to obtain an excellent sense of sound localization. The narrow speaker units attached to the right portion 202R and left portion 202L are not especially limited but may be, for example, the narrow speaker units 10 according to the first embodiment.

### Third Embodiment

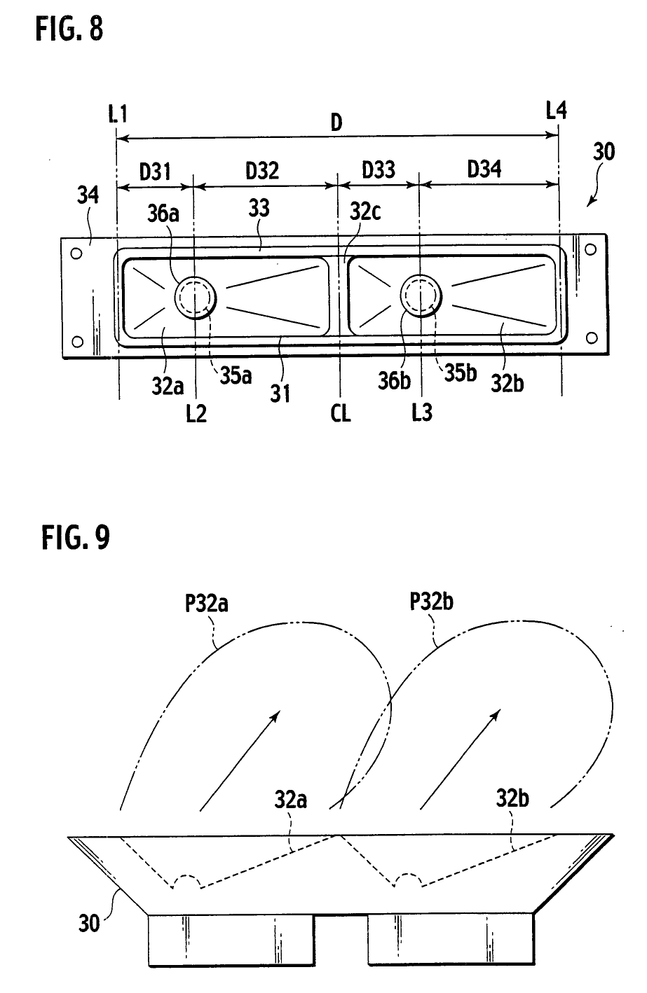

In a third embodiment of the present invention, a description is mainly given of points different from the first embodiment, and a description of common portions is properly omitted. FIG. 8 is a front view showing a narrow speaker unit according to the third embodiment of the present invention. As shown in FIG. 8, a narrow speaker unit 30 of the third embodiment includes a single diaphragm 31. The diaphragm 31 is rectangular with corners rounded off in a front view of the sound emitting surface and includes two cone-type vibrating sections 32a and 32b of the same size. The vibrating sections 32a and 32b are connected by a connecting section 32c. The outer peripheral edge of the diaphragm 31 is fixed to a frame 34 by an edge 33.

As shown in FIG. 8, the vibrating section 32a is an oblique cone type with the positions of a bobbin 35a and a dust cap 36a being displaced from the center of the vibrating section 32a outwardly toward the opposite side to a central line CL of the connecting section 32c in the length direction of the vibrating section 32a. The central line CL is a line at the center of a length D of the diaphragm 31. On the other hand, the vibrating section 32b is an oblique cone type with the positions of a bobbin 35b and a dust cap 36b being displaced inwardly toward the central line CL in the length direction of the vibrating section 32b. In the narrow speaker unit 30 according to the third embodiment, a distance D31 between the lines L1 and L2, a distance D32 between the line L2 and central line CL, a distance D33 between the central line CL and line L3, and a distance D34 between the lines L3 and L4 have the following relations:

D31=D33, D32=D34, D31<D32, and D33<D34

In the narrow speaker unit 30 according to the third embodiment, similar to the narrow speaker unit 10 according to the first embodiment, the vibrating sections 32a and 32b are the oblique cone type with drive centers being displaced from the respective centers of the vibrating sections 32a and 32b in the length direction. The partial resonance occurring in the narrow speaker unit 30 can be therefore reduced as compared to the partial resonance of the speaker unit of the related art.

Next, a description is given of a preferred way to attach the narrow speaker unit 30 to the image display apparatus considering a sound radiation pattern specific to the narrow speaker unit 30 according to the third embodiment. The sound radiation pattern emitted from the narrow speaker unit 30 in a view from an end in the length direction is the radiation pattern P1 shown in FIG. 3A, which is the same as the radiation pattern of the first embodiment. FIG. 9 is a schematic side plan view of the narrow speaker unit 30 with the length direction horizontal. The vibrating sections 32a and 32b are the oblique cone type with the bobbins 35a and 35b (drive centers) being displaced toward an end of the narrow speaker unit 30 in the length direction, respectively. Accordingly, the sound radiation patterns emitted from the vibrating sections 32a and 32b are radiation patterns P32a and P33b unevenly extending toward the right in FIG. 9.

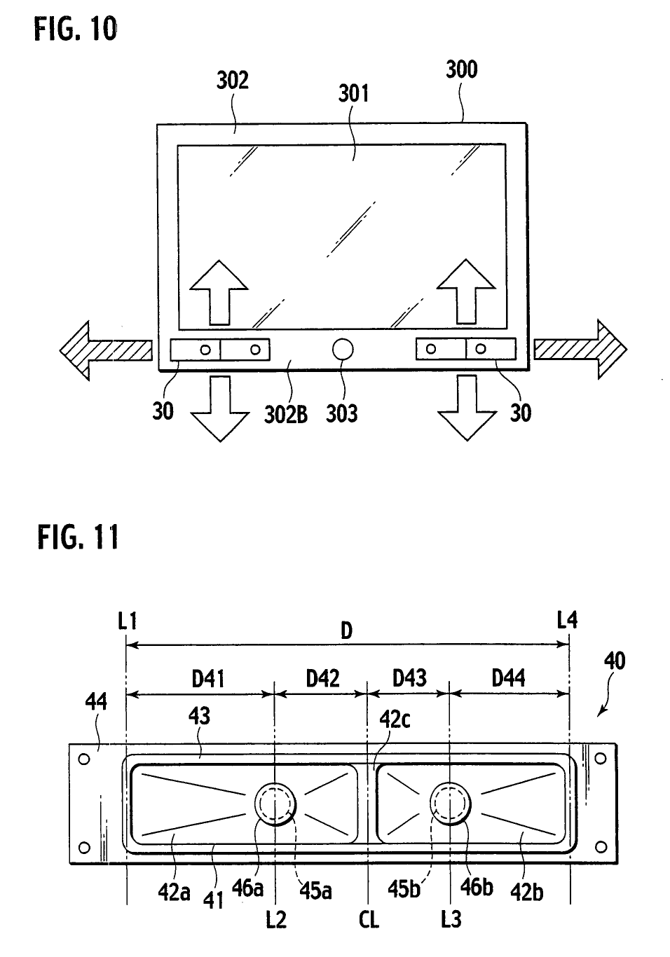

Since the narrow speaker unit 30 according to the third embodiment includes the radiation patterns P32a and P32b shown in FIG. 9, it is preferable that the narrow speaker unit 30 is arranged under a screen 301 of the image display apparatus 300 as shown in FIG. 10. Specifically, it is preferable to attach the narrow speaker units 30 to right and left ends of a bottom portion 302B of the front panel 302 with the length direction horizontal. More specifically, one of the narrow speaker units 30 is attached to the left end of the bottom portion 302B as a left speaker with the bobbins 35a and 35b being displaced toward the right (inwardly), and the other narrow speaker unit 30 is attached to the right end of the bottom portion 302B as a right speaker with the bobbins 35a and 35b being displaced toward the left (inwardly). Sound from the narrow speaker unit 30 as the left speaker is emitted toward the left as indicated by a hatched arrow, and sound from the narrow speaker unit 30 as the right speaker is emitted toward the right as indicated by the other hatched arrow.

In the image display apparatus 300 shown in FIG. 10, a center speaker 303 is attached to the middle of the bottom portion 302B. The center speaker 303 is not essential, but is preferably provided. When the narrow speaker units 30 are attached to the right and left ends of the bottom portion 302B of the front panel 302 as shown in FIG. 10, it is possible to obtain a sense of excellent sound spread. When the center speaker 303 is additionally attached, the sense of sound localization in the middle of the screen 301 improves.

### Fourth Embodiment

In a fourth embodiment of the present invention, a description is mainly given of points different from the first embodiment, and a description of common portions is properly omitted. FIG. 11 is a front view showing a narrow speaker unit according to the fourth embodiment of the present invention. As shown in FIG. 11, a narrow speaker unit 40 according to the fourth embodiment includes a single diaphragm 41. The diaphragm 41 is rectangular with corners rounded off in a front view of the sound emitting surface and includes two cone-type vibrating sections 42a and 42b. The vibrating sections 42a and 42b are connected by a connecting section 42c. The narrow speaker unit 40 is different from the narrow speaker unit 10 according to the first embodiment in that the vibrating sections 42a and 42b are different in size. In an example shown in FIG. 11, the vibrating section 42a is longer than the vibrating section 42b. The outer peripheral edge of the diaphragm 41 is fixed to a frame 44 by an edge 43.

As shown in FIG. 11, the vibrating section 42a is an oblique cone type with the positions of a bobbin 45a and a dust cap 46a being displaced inwardly toward a central line CL of the connecting section 42c in the length direction of the vibrating section 42a. In the fourth embodiment, the central line CL is not located at the center of a length D of the diaphragm 41. The vibrating section 42b is an oblique cone type with the positions of a bobbin 45b and a dust cap 46b being displaced inwardly toward the central line CL of the connecting section 42c in the length direction of the vibrating section 42b. In the narrow speaker unit 40 according to the fourth embodiment, a distance D41 between the lines L1 and L2, a distance D42 between the line L2 and central line CL, a distance D43 between the central line CL and line L3, and a distance D44 between the lines L3 and L4 have the following relations:

D41>D42, D43<D44, D41>D44, and D42>D43

In the narrow speaker unit 40 according to the fourth embodiment, similar to the narrow speaker unit 10 according to the first embodiment, each of the vibrating sections 42a and 42b is an oblique cone type. The partial resonance occurring in the narrow speaker unit 40 can be therefore reduced as compared to the partial resonance of the speaker unit of the related art. Furthermore, since the vibrating sections 42a and 42b are different in size, resonant frequencies at which the partial resonance occurs are different from each other in the vibrating sections 42a and 42b. The partial resonance occurring in the narrow speaker unit 40 according to the fourth embodiment can be therefore reduced as compared to the narrow speaker unit 10 according to the first embodiment.

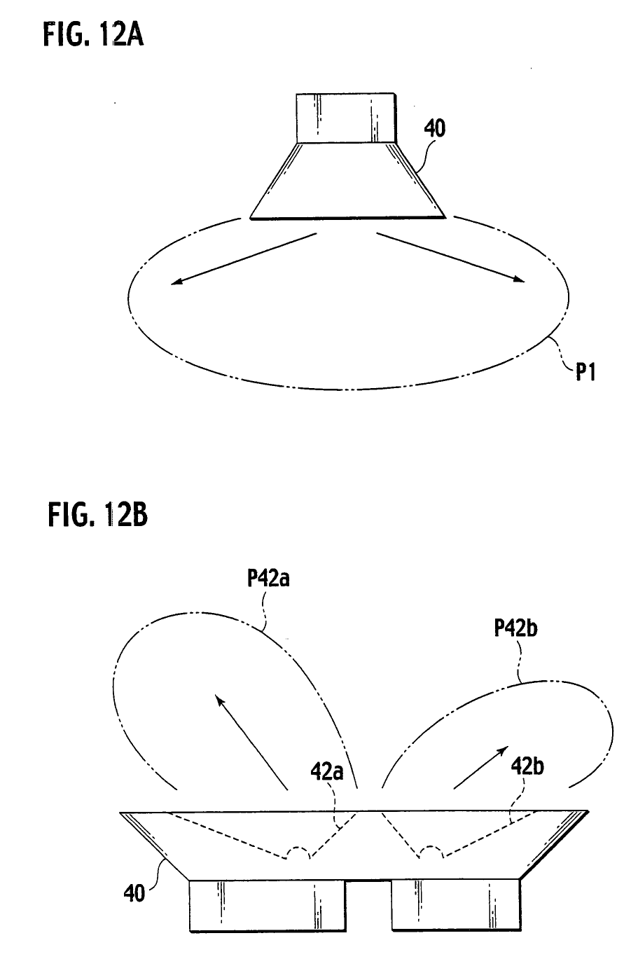

Next, a description is given of a preferred way to attach the narrow speaker unit 40 to the image display apparatus considering a sound radiation pattern specific to the narrow speaker unit 40 according to the fourth embodiment. FIG. 12A is a schematic plan view of the narrow speaker unit 40 from an end in the length direction, and FIG. 12B is a schematic side plan view of the narrow speaker unit 40 with the length direction horizontal. As shown in FIG. 12A, the sound radiation pattern emitted from the speaker unit 40 in the view from an end in the length direction is the radiation pattern P1, which is the same as the radiation pattern in the case of the first embodiment shown in FIG. 3A. The vibrating sections 42a and 42b are the oblique cone type with the bobbins 45a and 45b being displaced toward the central line CL, respectively. Accordingly, in a side view, the sound radiation patterns emitted from the vibrating sections 42a and 42b are respectively radiation patterns P42a and P43b unevenly spreading outward as shown in FIG. 12B. The vibrating sections 42a and 42b are different in size, and sound pressure produced by the radiation pattern P42a is larger than sound pressure by the radiation pattern P42b.

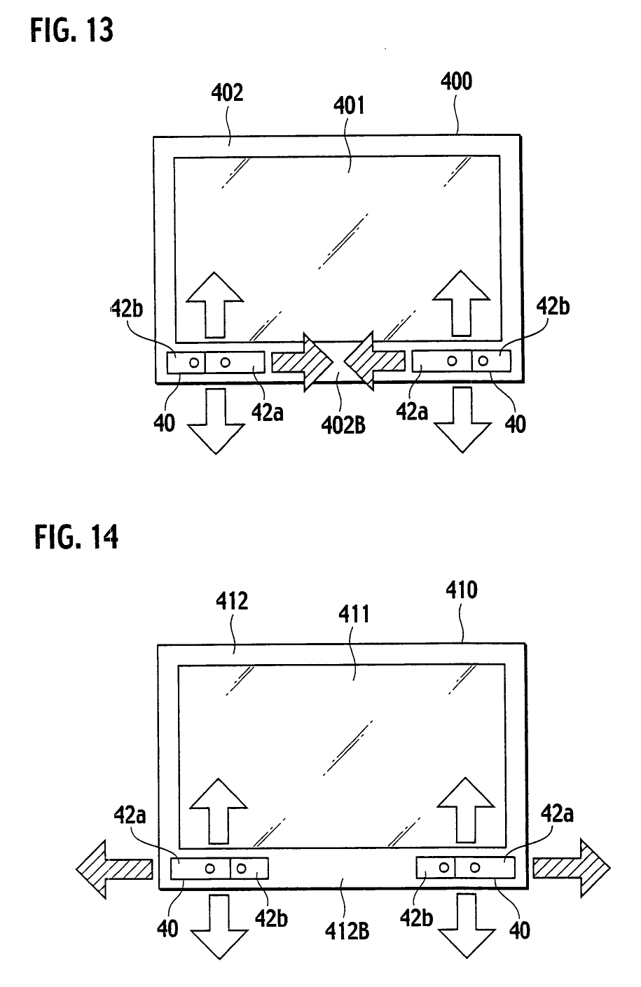

Since the narrow speaker unit 40 of the fourth embodiment includes the radiation patterns P42a and P42b shown in FIG. 12B, it is preferable that the narrow speaker unit 40 is arranged under a screen 401 of an image display apparatus 400 as shown in FIG. 13 as a first example. Specifically, it is preferable to attach the narrow speaker units 40 to the right and left ends of a bottom portion 402B of a front panel 402 with the length direction horizontal so that the vibrating sections 42a having larger area are located laterally inside. Positioned in such a manner, the narrow speaker unit 40 as a left speaker emits sound toward the right (inwardly) as indicated by a hatched arrow while the narrow speaker unit 40 as a right speaker emits sound toward the left (inwardly) as indicated by the other hatched arrow.

In the image display apparatus 400 shown in FIG. 13, it is possible to obtain an excellent sense of sound localization in the center of the screen 401 (so-called excellent center localization). Moreover, the vibrating section 42b having a smaller area can reproduce high frequency sounds better than the vibrating section 42a. Accordingly, the narrow speaker unit 40 is more excellent in high frequency reproduction characteristics than the narrow speaker unit 10 according to the first embodiment. Furthermore, since the vibrating sections 42b are located away from each other at the right and left ends of the bottom portion 402b, it is possible to obtain good separation in the high frequency range.

In FIG. 14, an image display apparatus 410 to which the narrow speaker unit 40 is attached shows a way of arranging the unit 40 as a second example. As shown in FIG. 14, in the second example, the narrow speaker units 40 are arranged by being attached to right and left ends of a bottom portion 412B of the front panel 412 with the length direction horizontal so that the large area vibration sections 42a are located outwardly from each other. Positioned in such a manner, the narrow speaker unit 40 as the left speaker emits sound toward the left (outwardly) as indicated by a hatched arrow while the narrow speaker unit 40 as a right speaker emits sound toward the right (outwardly) as indicated by the other hatched arrow. The image display apparatus 410 shown in FIG. 14 can provide an excellent sound spread in the intermediate frequency range.

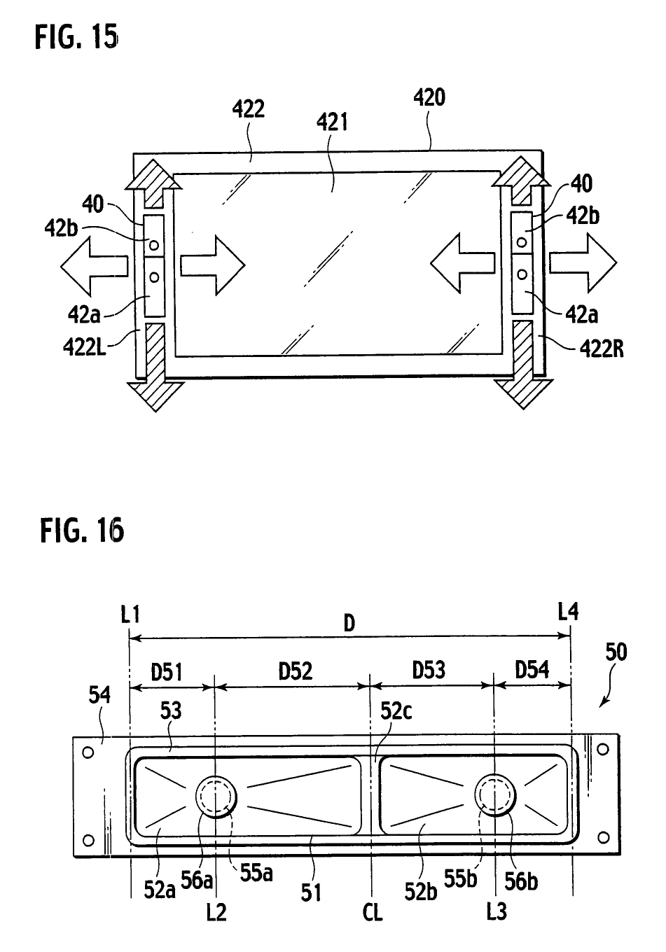

In FIG. 15, an image display apparatus 420 to which the narrow speaker unit 40 is attached shows a way of arranging the unit 40 as a third example. As shown in FIG. 15, in the third example, the narrow speaker units 40 are arranged by being attached to right portion 422R and left portion 422L of a front panel 422 with the length direction vertical so that the smaller area vibrating sections 42b located on the upper side. In the image display apparatus 420 shown in FIG. 15, similar to the case of FIG. 4, sound spreads vertically and horizontally from the right and left narrow speaker units 40, and an excellent spread of sound can be obtained. Moreover, the small area vibrating section 42b can reproduce high frequency sounds very well. The narrow speaker unit 40 can be attached so that the vibrating sections 42b are located on the lower side, but it is more preferable that the vibrating section 42b is located on the upper side as shown in FIG. 15.

### Fifth Embodiment

In a fifth embodiment of the present invention, a description is mainly given of points different from the second embodiment, and a description of common portions is properly omitted. FIG. 16 is a front view showing a narrow speaker unit according to the fifth embodiment of the present invention. As shown in FIG. 16, a narrow speaker unit 50 according to the fifth embodiment includes a single diaphragm 51. The diaphragm 51 is rectangular with corners rounded off in a front view of the sound emitting surface and includes two cone-type vibrating sections 52a and 52b. The vibrating sections 52a and 52b are connected by a connecting section 52c. The narrow speaker unit 50 is different from the narrow speaker unit 20 according to the second embodiment in that the vibrating sections 52a and 52b are different in size. In an example shown in FIG. 16, the vibrating section 52a is longer than the vibrating section 52b. The outer peripheral edge of the diaphragm 51 is fixed to a frame 54 by an edge 53.

As shown in FIG. 16, the vibrating section 52a is an oblique cone type with the positions of a bobbin 55a and a dust cap 56a being displaced outwardly toward the opposite side with respect to a central line CL of the connecting section 52c in the length direction of the vibrating section 52a. Also in the fifth embodiment, the central line CL is not located at the center of a length D of the diaphragm 51. The vibrating section 52b is an oblique cone type with the positions of a bobbin 55b and a dust cap 56b being displaced outwardly toward the opposite side with respect to the central line CL in the length direction of the vibrating section 52b. In the narrow speaker unit 50 according to the fifth embodiment, a distance D51 between the lines L1 and L2, a distance D52 between the line L2 and central line CL, a distance D53 between the central line CL and line L3, and a distance D54 between the lines L3 and L4 have the following relations:

D51<D52, D53>D54, D51>D54, and D52>D53

In the narrow speaker unit 50 according to the fifth embodiment, similar to the narrow speaker unit 20 according to the second embodiment, each of the vibrating sections 52a and 52b is of the oblique cone type with the drive center being displaced from the center thereof. The partial resonance occurring in the narrow speaker unit 50 can be therefore reduced as compared to the partial resonance of the speaker unit of the related art. Furthermore, since the vibrating sections 52a and 52b are different in size, the partial resonance occurring in the narrow speaker unit 50 can be reduced as compared to the partial resonance of the narrow speaker unit 20 according to the second embodiment.

Next, a description is given of a preferred way to attach the narrow speaker unit 50 to the image display apparatus considering a sound radiation pattern specific to the narrow speaker unit 50 according to the fifth embodiment. The sound radiation pattern emitted from the speaker unit 50 in the view from an end in the length direction is the radiation pattern P1, which is the same as the radiation pattern in the case of the first embodiment shown in FIG. 3A. The vibrating sections 52a and 52b are of the oblique cone type with the bobbins 55a and 55b being displaced outwardly toward the opposite side with respect to the central line CL. Accordingly, in a side view, similar to FIG. 6, the sound radiation patterns emitted from the vibrating sections 52a and 52b are respectively radiation patterns P52a and P52b unevenly spreading inwardly. However, the vibrating sections 52a and 52b are different in size, and sound pressure of the radiation pattern P52a is larger than the sound pressure of the radiation pattern P52b.

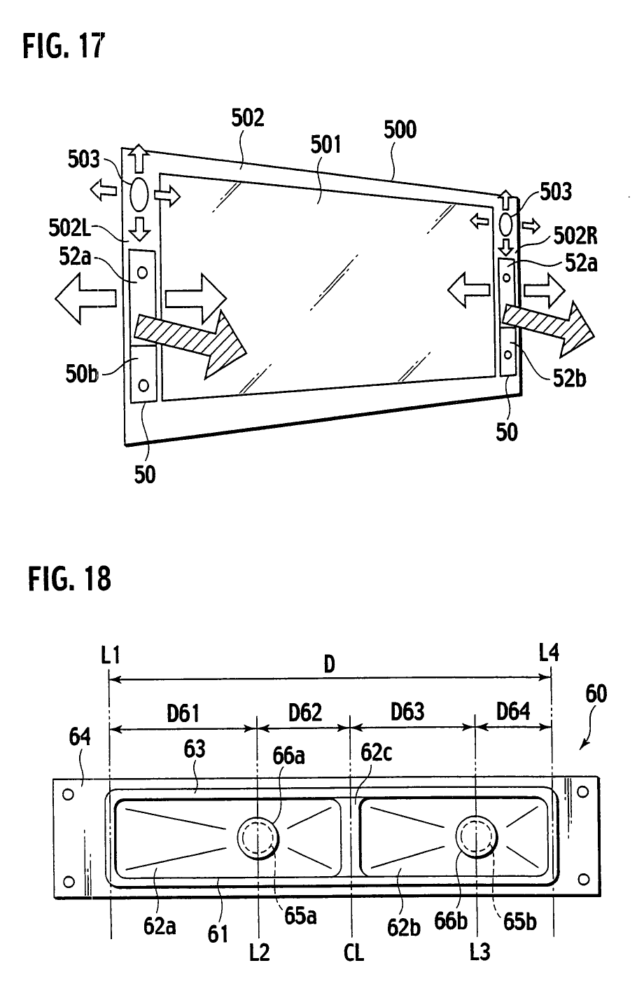

Since the narrow speaker unit 50 according to the fifth embodiment includes the aforementioned radiation patterns, as shown in FIG. 17, it is preferable that the narrow speaker unit 50 is arranged to either side of a screen 501 of an image display apparatus 500. Specifically, it is preferable to attach the narrow speaker units 50 to right portion 502R and left portion 502L of a front panel 502 with the length direction vertical. The vibrating sections 52a are arranged on the upper side in FIG. 17, however the vibrating sections 52b may be arranged on the upper side.

In the narrow speaker unit 50, both sound radiation patterns emitted from the vibration sections 52a and 52b unevenly spread toward the central line CL. Accordingly, the radiation patterns are combined as shown in FIG. 17, and sound is emitted forwardly from the center of the narrow speaker unit 50 in the length direction as indicated by a hatched arrow. The image display apparatus 500 can provide a clear, inward localization between the vibrating sections 52a and 52b in the length direction. FIG. 17 shows an example in which tweeters 503 are attached above the right and left narrow speaker units 50. Sound spreads from the tweeters 503 in all directions.

### Sixth Embodiment

In a sixth embodiment of the present invention, a description is mainly given of points different from the third embodiment, and a description of common portions is properly omitted. FIG. 18 is a front view showing a narrow speaker unit according to the sixth embodiment of the present invention. As shown in FIG. 18, a narrow speaker unit 60 according to the sixth embodiment includes a single diaphragm 61. The diaphragm 61 is rectangular with corners rounded off in a front view of the sound emitting surface and includes two cone-type vibrating sections 62a and 62b. The vibrating sections 62a and 62b are connected by a connecting section 62c. The narrow speaker unit 60 is different from the narrow speaker unit 30 according to the third embodiment in that the vibrating sections 62a and 62b are different in size. In the example shown in FIG. 18, the vibrating section 62a is longer than the vibrating section 62b. The outer peripheral edge of the diaphragm 61 is fixed to a frame 64 by an edge 63.

As shown in FIG. 18, the vibrating section 62a is an oblique cone type with the positions of a bobbin 65a and a dust cap 66a being displaced inwardly toward a central line CL of the connecting section 62c in the length direction of the vibrating section 62a. Also in the sixth embodiment, the central line CL is not located at the center of a length D of the diaphragm 61. The vibrating section 62b is an oblique cone type with the positions of a bobbin 65b and a dust cap 66b being displaced outwardly toward the opposite side with respect to the central line CL in the length direction of the vibrating section 62b. In the narrow speaker unit 60 according to the sixth embodiment, a distance D61 between the lines L1 and L2, a distance D62 between the line L2 and central line CL, a distance D63 between the central line CL and line L3, and a distance D64 between the lines L3 and L4 have the following relations:

D61>D62, D63>D64, D61>D63, and D62>D64

In the narrow speaker unit 60 according to the sixth embodiment, similar to the narrow speaker unit 30 according to the third embodiment, each of the vibrating sections 62a and 62b is of the oblique cone type with the drive center being displaced from the center thereof. The partial resonance occurring in the narrow speaker unit 60 can be reduced as compared to the partial resonance of the speaker unit of the related art. Furthermore, since the vibrating sections 62a and 62b are different in size, the partial resonance occurring in the narrow speaker unit 60 can be reduced as compared to the partial resonance of the narrow speaker unit 30 according to the third embodiment.

Next, a description is given of a preferred way to attach the narrow speaker unit 60 to the image display apparatus considering a sound radiation pattern specific to the narrow speaker unit 60 according to the sixth embodiment. The sound radiation pattern emitted from the speaker unit 60 in the view from an end in the length direction is the radiation pattern P1, which is the same as the radiation pattern in the case of the first embodiment shown in FIG. 3A. The vibrating sections 62a and 62b are of the oblique cone type with the bobbins 65a and 65b (drive centers) being displaced toward an end of the narrow speaker unit 60 in the length direction. Accordingly, the sound radiation patterns emitted from the vibrating sections 62a and 62b are radiation patterns spreading in the direction opposite to the direction that the drive centers are displaced. However, the vibrating sections 62a and 62b are different in size, and sound pressure created by the radiation pattern P62a is larger than sound pressure created by the radiation pattern P62b.

Since the narrow speaker unit 60 according to the sixth embodiment includes the aforementioned radiation pattern, as shown in FIG. 19, it is preferable that the narrow speaker unit 60 is arranged under a screen 601 of an image display apparatus 600. Specifically, it is preferable to attach the narrow speaker units 60 to horizontal ends of a bottom portion 602B of a front panel 602 with the length direction horizontal. More specifically, the narrow speaker unit 60 as a left speaker is attached to the left end of the bottom portion 602B with the vibrating section 62a directed outwardly so that the bobbins 65a and 65b are displaced toward the right (inwardly), and the narrow speaker unit 60 as a right speaker is attached to the right end of the bottom portion 602B with the vibrating section 62a directed outwardly so that the bobbins 65a and 65b are displaced toward the left (inwardly). By being positioned in such a manner, sound is horizontally emitted from the right and left narrow speaker units 60 as indicated by hatched arrows.

In the image display apparatus 600 shown in FIG. 19, a center speaker 603 is attached to the center of the bottom portion 602B. The center speaker 603 is not essential but is preferred. By attaching the narrow speaker units 60 to the horizontal ends of the bottom portion 602B of the front panel 602 as shown in FIG. 19, it is possible to obtain an excellent sound spread. When the center speaker 603 is attached, the sense of sound localization in the center of the screen 601 is improved.

### Seventh Embodiment

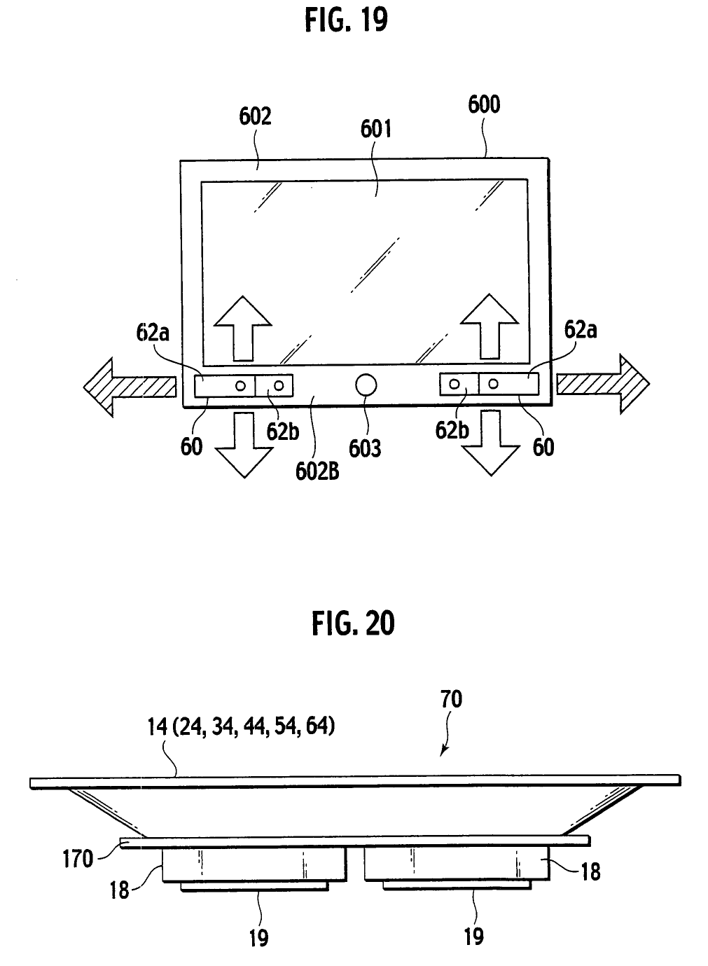

In a seventh embodiment of the present invention, a description is mainly given of points different from the first to sixth embodiments, and a description of common portions is properly omitted. FIG. 20 is a side view showing a narrow speaker unit according to the seventh embodiment of the present invention. The basic configuration of the narrow speaker unit 70 according to the seventh embodiment is the same as the basic configuration of the narrow speaker units 10, 20, 30, 40, 50, and 60 according to the first to sixth embodiments. In the narrow speaker units 10, 20, 30, 40, 50, and 60 according to the first to sixth embodiments, the top plates 17 are independently provided for the two vibrating sections. However, in the narrow speaker unit 70, a difference exists where a single top plate 170 is shared by the two vibrating sections. According to the narrow speaker unit 70 of the seventh embodiment, mechanical strength is increased. Such a structure is effective as a reinforcement of the strength, especially when the frame 14 (24, 34, 44, 54, and 64) is formed of a non-metallic material such as resin. Moreover, it is possible to reduce the work time to fix the top plates 170 to the frame 14 (24, 34, 44, 54, and 64).

### <Frequency Characteristic Comparison>

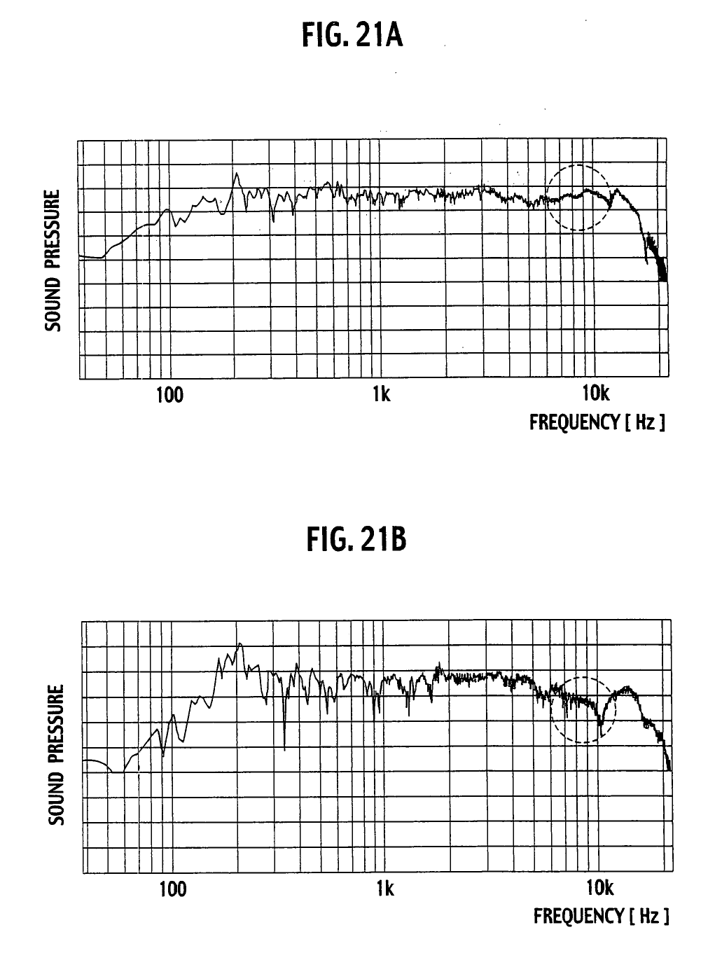

Herein, the frequency characteristics between the embodiments of the narrow speaker unit according to the present invention and the narrow speaker unit of the related art are compared, with refer to FIGS. 21A and 21B. FIG. 21A shows the frequency characteristic of the narrow speaker unit 40 according to the fourth embodiment as representative among the narrow speaker units 10, 20, 30, 40, 50, and 60 according to the first to sixth embodiments. FIG. 21A shows the frequency characteristic of the narrow speaker unit 40 according to the fourth embodiment. FIG. 21B shows the frequency characteristic of a narrow speaker unit in which a track-type diaphragm is provide with two track type vibrating sections of the same size, neither of which are not the oblique cone type.

In the narrow speaker unit including the two vibrating sections which are not of the oblique cone type, as indicated by a dashed circle in FIG. 21B, the sound pressure level is low in a range of 7 to 10 kHz, and a muffled voice (sound) is obtained in reproduced sound. On the other hand, in the narrow speaker unit 40 according to the fourth embodiment shown in FIG. 21A, the sound pressure level is substantially flat in a range of 7 to 10 kHz, and it is possible to obtain clear reproduced sound without being muffled.

Only the frequency characteristic of the narrow speaker unit 40 according to the fourth embodiment is shown herein, but the narrow speaker units 10, 20, 30, 50, and 60 according to the first to third, fifth, and sixth embodiments provide better frequency characteristics than the frequency characteristic shown in FIG. 21B.

### <Modifications>

In each embodiment described above, the configuration including the single diaphragm provided with the two vibrating sections is shown, but the single diaphragm may include three or more vibrating sections. In such a case, it is only necessary that two of the three or more vibrating sections form the aforementioned configuration of each embodiment. Moreover, the narrow speaker unit according to each embodiment is suitable for use in an image display apparatus such as a television receiver but may be used as a speaker unit attached to audio equipment.

Various modifications will become possible for those skilled in the art after receiving the teachings of the present disclosure without departing from the scope thereof.

What is claimed is:

1. A narrow speaker unit having an elongated shape with a longitudinal direction and a lateral direction from a view of a sound emitting surface, the narrow speaker unit comprising:
a diaphragm including first and second cone-type vibrating sections arranged in the longitudinal direction and integrally formed, each of the first and second vibrating sections having an elongated shape with respect to the longitudinal and lateral directions;
a first drive section configured to drive the first vibrating section, the first drive section being attached to the first vibrating section with a drive center of the first vibrating section being displaced in the longitudinal direction from a central position of the first vibrating section in the longitudinal direction; and
a second drive section configured to drive the second vibrating section, the second drive section being attached to the second vibrating section with a drive center of the second vibrating section being displaced in the longitudinal direction from a central position of the second vibrating section in the longitudinal direction.

2. The narrow speaker unit of claim 1, wherein the first and second drive sections are displaced toward the center of the narrow speaker unit in the longitudinal direction and attached to the first and second vibrating sections, respectively.

3. The narrow speaker unit of claim 1, wherein the first and second drive sections are displaced toward respective sides opposite to the center of the narrow speaker unit in the longitudinal direction and attached to the first and second vibrating sections, respectively.

4. The narrow speaker unit of claim 1, wherein the first drive section is displaced outwardly in the longitudinal direction toward a side opposite to the center of the narrow speaker unit and attached to the first vibrating section and the second drive section is displaced inwardly in the longitudinal direction toward the center of the narrow speaker unit and attached to the second vibrating section.

5. The narrow speaker unit of claim 2, wherein length of the first vibrating section in the longitudinal direction is greater than length of the second vibrating section in the longitudinal direction.

6. The narrow speaker unit of claim 3, wherein length of the first vibrating section in the longitudinal direction is greater than length of the second vibrating section in the longitudinal direction.

7. The narrow speaker unit of claim 4, wherein length of the second vibrating section in the longitudinal direction is greater than length of the first vibrating section in the longitudinal direction.

8. An image display apparatus comprising:
narrow speaker units according to claim 2 which are arranged in right and left portions of a front panel around a display screen so that the longitudinal directions of the speaker units is vertical.

9. An image display apparatus comprising:
a narrow speaker unit according to claim 3 which is arranged in a bottom central portion of a front panel around a display screen so that the longitudinal direction of the speaker unit is horizontal.

10. An image display apparatus comprising:
narrow speaker units according to claim 4 which are arranged at right and left ends of a bottom portion of a front panel around a display screen so that the longitudinal direction of the speaker units is horizontal, wherein
the first vibrating sections are located horizontally inwardly in the bottom portion and the second vibrating sections are located horizontally outwardly in the bottom portion.

11. An image display apparatus comprising:
narrow speaker units according to claim 5 which are arranged at right and left ends of a bottom portion of a front panel around a display screen so that the longitudinal direction of the speaker units is horizontal, wherein
the first vibrating sections are located horizontally inwardly in the bottom portion and the second vibrating sections are located horizontally outwardly in the bottom portion.

12. An image display apparatus comprising:
narrow speaker units according to claim 5 which are arranged at right and left ends of a bottom portion of a front panel around a display screen so that the longitudinal direction of the speaker unit is horizontal, wherein
the first vibrating sections are located horizontally outwardly in the bottom portion and the second vibrating sections are located horizontally inwardly in the bottom portion.

13. An image display apparatus comprising:
narrow speaker units according to claim 5 which are arranged in right and left portions of a front panel around a display screen so that the longitudinal direction of the units is vertical, wherein
the first and second vibrating sections of each of the narrow speaker units are respectively located on lower and upper sides of one of the right and left portions.

14. An image display apparatus comprising:
narrow speaker units according to claim 6 which are arranged in right and left portions of a front panel around a display screen so that the longitudinal direction of the speaker units is vertical.

15. An image display apparatus comprising:
narrow speaker units according to claim 7 which are arranged at right and left ends of a bottom portion of a front panel around a display screen so that the longitudinal direction of the speaker units is horizontal, wherein
the first vibrating sections are located horizontally inwardly in the bottom portion and the second vibrating sections are located horizontally outwardly in the bottom portion.
